(19) United States
(12) Patent Application Publication
(10) Pub. No.: US 2024/0254280 A1
(43) Pub. Date: Aug. 1, 2024

(54) PLANT-BASED SUPPLE AND DURABLE TOPCOATS

(71) Applicant: von Holzhausen, Pacific Palisades, CA (US)

(72) Inventors: Dayong Chen, Los Angeles, CA (US); Vicki von Holzhausen, Pacific Palisades, CA (US); Jessie Junting Chen, Los Angeles, CA (US); Craig Andrew Machado, Burbank, CA (US)

(21) Appl. No.: 18/412,383

(22) Filed: Jan. 12, 2024

Related U.S. Application Data
(60) Provisional application No. 63/480,004, filed on Jan. 15, 2023.

(51) Int. Cl. C08G 63/81; C08G 59/32; C08G 59/42; C08J 9/28

(52) U.S. Cl. CPC C08G 63/81; C08G 59/32; C08G 59/4207; C08J 9/286; C08J 2201/0502; C08J 2367/00

(57) ABSTRACT

Plant-based supple and durable topcoats are achieved by reacting naturally derived epoxides with naturally derived polyfunctional carboxylic acids. The topcoats are coated to various types of substrates including weaved or knitted or nonwoven fabrics, and can show significant advantages of replacing both animal hide leathers and petroleum-based PU leathers by reducing the carbon footprints, and improving environmental sustainability.

### 1. CROSS-REFERENCE TO RELATED APPLICATIONS

This application claims the benefit of U.S. Provisional Patent Application No. 63/480,004, filed on Jan. 15, 2023, which is incorporated by reference herein in its entirety.

### 2. BACKGROUND

The leather industry is one of the most polluting industries. Raising the animals whose skin eventually becomes leather requires vast quantities of water and wide tracts of pastureland, which must be cleared of trees. In fact, in the last few decades, 70 percent of the Amazon rainforest has been cleared to make way for pastures or for growing feed crops. This mass deforestation causes habitat loss for millions of species, eliminates the Earth's tree canopy, and drives climate change. Use of different chemicals during leather processing produces wastes in solid, liquid and gaseous form. As per 2014, chromium (III) tanning accounts for around 85 percent of global leather production, and all wastes containing chromium are considered hazardous by the Environmental Protection Agency (EPA). Customer awareness of such environmental pollution and animal cruelty involved in the leather industry has pivoted the markets towards more sustainable synthetic vegan leather alternatives.

### 2.1. Related Field

Synthetic vegan leathers in the art are primarily made of two types of polymers: plasticized polyvinyl chloride (PVC) and formulated 2-components polyurethane (PU) or water-borne polyurethane dispersion. They can be engineered to have mechanical properties (e.g. modulus, elongation and strength) comparable to those of animal hide leathers. A recent trend is to make these materials more environmentally sustainable. Although efforts of using epoxidized plant-based oils as PVC plasticizers and using plant-based polyols and isocyanates in polyurethane formula have led to significant progresses in lowering the toxicity and carbon emission of synthetic vegan leathers, it is very difficult or impossible to obtain 100% all plant-based PVC and PU chemistry. Furthermore, these petroleum-based PVC and PU vegan leathers are not biodegradable, leading to long-lasting plastic pollution. Therefore, it is desirable to create 100% plant-based topcoats with low carbon footprints.

### 2.2. Description of Related Art

Plant-based elastomeric coatings can be prepared by reacting an epoxidized vegetable oil with a naturally-occurring polyfunctional carboxylic acid. An exemplary epoxidized vegetable oil is epoxidized soybean oil and an exemplary polyfunctional carboxylic acid is citric acid. However, due to the high epoxy functionality of epoxidized soybean oil and high carboxylic acid functionality of citric acid, and their relatively small molecular weights, such cured coating tends to have very high crosslinking density, and thereby lack the elongation of typical animal hide leathers and synthetic vegan leathers. It is desirable to create plant-based supple and durable topcoats with similar mechanical properties and haptics of animal hide leathers.

### 3. SUMMARY

In one aspect of the invention, a composition includes a combination of naturally derived epoxies with naturally derived polyfunctional carboxylic acid, where the materials are monomers or oligomers and wherein the composition is in the form of a coating. In one embodiment, the coating is a topcoat for a synthetic leather construct.

In one embodiment, a coating comprises a combination of polymerized materials selected from: (i) one or more naturally derived epoxides; and (ii) one or more naturally derived polyfunctional carboxylic acids, wherein a weight percent of plant derived carbon in the coating is at least 90%.

In accordance with any of the embodiments, the weight percent of plant-based carbon content in the coating is above 96%.

In accordance with any of the embodiments, the one or more naturally derived epoxides are epoxidized plant-based oils selected from: epoxidized canola oil, epoxidized corn oil, epoxidized linseed oil, epoxidized grape seed oil, epoxidized hemp seed oil, epoxidized olive oil, epoxidized peanut oil, epoxidized sesame oil, epoxidized soybean oil, epoxidized walnut oil, epoxidized sunflower oil, epoxidized high oleic canola oil, epoxidized high oleic sunflower oil, and epoxidized high oleic soybean oil.

In accordance with any of the embodiments, the one or more polyfunctional carboxylic acids is selected from: monomer-type di-carboxylic acids including at least one of azelaic acid, sebacic acid, aconitic acid, a-keto glutaric acid, tartaric acid, fumaric acid, malic acid, citric acid, dodecanedioic acid, dimerized fatty acids, hydrogenated dimerized fatty acids, and Elevance Inherent® C18 diacid; and polymer-type di-carboxylic acids including at least one of polyester di-carboxylic acids, polyamide di-carboxylic acids, polyether di-carboxylic acids, and polycarbonate di-carboxylic acids.

In accordance with any of the embodiments, the epoxidized plant-based oils include epoxidized soybean oil Vikoflex® 7170.

In accordance with any of the embodiments, the epoxidized plant-based oils include epoxidized linseed oil selected from Vikoflex® 7190 and EPOXOL® 9-5™.

In accordance with any of the embodiments, the plant-derived epoxides are epoxidized modified plant-based oils including epoxidized propylene glycol dioleate selected Vikoflex® 5075 and sucrose soyate Sefose®.

In accordance with any of the embodiments, the one or more naturally derived epoxides include epoxidized modified plant-based oils, wherein the epoxidized modified plant-based oils include a first oil with a degree of epoxy functionality below 2.5 and a second oil with a degree of epoxy functionality above 6.

In accordance with any of the embodiments, the first oil is epoxidized propylene glycol dioleate and the second oil is epoxidized sucrose soyate.

In accordance with any of the embodiments, the naturally derived epoxides include naturally-based glycidyl-ether-type epoxies, wherein the naturally-based glycidyl-ether-type epoxies is formed by reacting plant-based multiple functional alcohol with 100% bio-based epichlorohydrin, wherein the plant-based multiple functional alcohol is selected from glycerol, sorbitol, isosorbide, and propanediol.

In accordance with any of the embodiments, the naturally-based glycidyl-ether-type epoxies is selected from DENACOL™ GEX-313, GEX-521, GEX-622, BRIOZEN® RD 124 G, and BRIOZEN® RD 135 G.

In accordance with any of the embodiments, the naturally derived epoxides include naturally-based glycidyl-ester-type epoxies, wherein the naturally-based glycidyl-ester-type epoxies is formed by a process of reacting plant-based multiple functional carboxylic acid with 100% bio-based epichlorohydrin, wherein the plant-based multiple functional carboxylic acid can be selected from dimer acids and sebacic acid.

In accordance with any of the embodiments, the naturally-based glycidyl-ester-type epoxies include BRIOZEN® RD 133 G.

In accordance with any of the embodiments, the one or more polyfunctional carboxylic acids includes a polyester di-carboxylic acid formed by reacting a polyester polyol with one or more di-carboxylic acid monomers.

In accordance with any of the embodiments, the one or more polyfunctional carboxylic acids includes a polyamide di-carboxylic acid formed from diamines generated by a bio-fermentation process.

In accordance with any of the embodiments, the one or more polyfunctional carboxylic acids includes a polyamide di-carboxylic acid formed from diamines generated by a bio-industrial process.

In accordance with any of the embodiments, the one or more polyfunctional carboxylic acids includes branched polycarboxylic acids or hyperbranched polycarboxylic acids.

In accordance with any of the embodiments, the branched polycarboxylic acids or hyperbranched polycarboxylic acids are prepared by reacting multifunctional carboxylic acids monomers, or multifunctional alcohols monomers, or multifunctional amines monomers in the polymerization.

In accordance with any of the embodiments, the one or more polyfunctional carboxylic acids are naturally derived polyfunctional carboxylic acids and not naturally occurring polyfunctional carboxylic acids.

In accordance with any of the embodiments, the coating further comprises one or more catalyst that enables thermal curing of the coating.

In accordance with any of the embodiments, the one or more catalyst is an amine, phosphonium or metal type catalyst with a weight loading ratio of 0.5-3%.

In accordance with any of the embodiments, the one or more catalyst includes at least one of Dabco® 33-LV, NACURE XC-2007, K-PURE CXC-1765 or CYPHOS® IL 169.

In accordance with any of the embodiments, the coating further comprises one or more fillers and additives.

In accordance with any of the embodiments, the one or more fillers are a fume-silica type with a weight loading ratio of 0.3-3%.

In accordance with any of the embodiments, the coating is characterized by a tensile elongation strain of 250% or greater, 350% or greater, or 550% or greater.

In one embodiment, a flexible substrate construct comprises: a plant-based fabric backing; and a coating comprising a combination of polymerized materials selected from: (i) one or more naturally derived epoxides; and (ii) one or more naturally derived polyfunctional carboxylic acids, wherein a weight percent of plant derived carbon in the coating is at least 90%.

In accordance with any of the embodiments, the flexible substrate construct further includes one or more plant-based pigments and dyes.

In accordance with any of the embodiments, the weight percent of plant-based carbon content in the coating is above 96%.

In accordance with any of the embodiments, the one or more naturally derived epoxides are epoxidized plant-based oils selected from: epoxidized canola oil, epoxidized corn oil, epoxidized linseed oil, epoxidized grape seed oil, epoxidized hemp seed oil, epoxidized olive oil, epoxidized peanut oil, epoxidized sesame oil, epoxidized soybean oil, epoxidized walnut oil, epoxidized sunflower oil, epoxidized high oleic canola oil, epoxidized high oleic sunflower oil, and epoxidized high oleic soybean oil.

In accordance with any of the embodiments, the one or more polyfunctional carboxylic acids is selected from: monomer-type di-carboxylic acids including at least one of azelaic acid, sebacic acid, aconitic acid, a-keto glutaric acid, tartaric acid, fumaric acid, malic acid, citric acid, dodecanedioic acid, dimerized fatty acids, hydrogenated dimerized fatty acids, and Elevance Inherent® C18 diacid; and polymer-type di-carboxylic acids including at least one of polyester di-carboxylic acids, polyamide di-carboxylic acids, polyether di-carboxylic acids, and polycarbonate di-carboxylic acids.

In accordance with any of the embodiments, the epoxidized plant-based oils include epoxidized soybean oil Vikoflex® 7170.

In accordance with any of the embodiments, the epoxidized plant-based oils include epoxidized linseed oil selected from Vikoflex® 7190 and EPOXOL® 9-5™.

In accordance with any of the embodiments, the plant-derived epoxides are epoxidized modified plant-based oils including epoxidized propylene glycol dioleate selected Vikoflex® 5075 and sucrose soyate Sefose®.

In accordance with any of the embodiments, the one or more naturally derived epoxides include epoxidized modified plant-based oils, wherein the epoxidized modified plant-based oils include a first oil with a degree of epoxy functionality below 2.5 and a second oil with a degree of epoxy functionality above 6.

In accordance with any of the embodiments, the first oil is epoxidized propylene glycol dioleate and the second oil is epoxidized sucrose soyate.

In accordance with any of the embodiments, the naturally derived epoxides include naturally-based glycidyl-ether-type epoxies, wherein the naturally-based glycidyl-ether-type epoxies is formed by reacting plant-based multiple functional alcohol with 100% bio-based epichlorohydrin, wherein the plant-based multiple functional alcohol is selected from glycerol, sorbitol, isosorbide, and propanediol.

In accordance with any of the embodiments, the naturally-based glycidyl-ether-type epoxies is selected from DENACOL™ GEX-313, GEX-521, GEX-622, BRIOZEN® RD 124 G, and BRIOZEN® RD 135 G.

In accordance with any of the embodiments, the naturally derived epoxides include naturally-based glycidyl-ester-type epoxies, wherein the naturally-based glycidyl-ester-type epoxies is formed by a process of reacting plant-based multiple functional carboxylic acid with 100% bio-based epichlorohydrin, wherein the plant-based multiple functional carboxylic acid can be selected from dimer acids and sebacic acid.

In accordance with any of the embodiments, the naturally-based glycidyl-ester-type epoxies include BRIOZEN® RD 133 G.

In accordance with any of the embodiments, the one or more polyfunctional carboxylic acids includes a polyester di-carboxylic acid formed by reacting a polyester polyol with one or more di-carboxylic acid monomers.

In accordance with any of the embodiments, the one or more polyfunctional carboxylic acids includes a polyamide di-carboxylic acid formed from diamines generated by a bio-fermentation process.

In accordance with any of the embodiments, the one or more polyfunctional carboxylic acids includes a polyamide di-carboxylic acid formed from diamines generated by a bio-industrial process.

In accordance with any of the embodiments, the one or more polyfunctional carboxylic acids includes branched polycarboxylic acids or hyperbranched polycarboxylic acids.

In accordance with any of the embodiments, the branched polycarboxylic acids or hyperbranched polycarboxylic acids are prepared by reacting multifunctional carboxylic acids monomers, or multifunctional alcohols monomers, or multifunctional amines monomers in the polymerization.

In accordance with any of the embodiments, the one or more polyfunctional carboxylic acids are naturally derived polyfunctional carboxylic acids and not naturally occurring polyfunctional carboxylic acids.

In accordance with any of the embodiments, the coating of the flexible construct further comprises one or more catalyst that enables thermal curing of the coating.

In accordance with any of the embodiments, the one or more catalyst is an amine, phosphonium or metal type catalyst with a weight loading ratio of 0.5-3%.

In accordance with any of the embodiments, the one or more catalyst includes at least one of Dabco® 33-LV, NACURE XC-2007, K-PURE CXC-1765 or CYPHOS® IL 169.

In accordance with any of the embodiments, the coating of the flexible construct further comprises one or more fillers and additives.

In accordance with any of the embodiments, the one or more fillers are a fume-silica type with a weight loading ratio of 0.3-3%.

In accordance with any of the embodiments, the coating is characterized by a tensile elongation strain of 250% or greater, 350% or greater, or 550% or greater.

In one embodiment, a process of making a coating comprises combining one or more naturally derived epoxides and one or more naturally derived polyfunctional carboxylic acids to obtain a mixture, wherein the materials are plant-based; combining the mixture with a solvent to create a liquid formula; coating the liquid formula on a fabric backing; and curing the liquid formula to form a coating on the fabric backing.

In accordance with any of the embodiments, the liquid formula includes one or more plant-based pigments and dyes.

In accordance with any of the embodiments, the weight percent of plant-based carbon content in the coating is above 96%.

In accordance with any of the embodiments, the one or more naturally derived epoxides are epoxidized plant-based oils selected from: epoxidized canola oil, epoxidized corn oil, epoxidized linseed oil, epoxidized grape seed oil, epoxidized hemp seed oil, epoxidized olive oil, epoxidized peanut oil, epoxidized sesame oil, epoxidized soybean oil, epoxidized walnut oil, epoxidized sunflower oil, epoxidized high oleic canola oil, epoxidized high oleic sunflower oil, and epoxidized high oleic soybean oil.

In accordance with any of the embodiments, the one or more polyfunctional carboxylic acids is selected from: monomer-type di-carboxylic acids including at least one of azelaic acid, sebacic acid, aconitic acid, a-keto glutaric acid, tartaric acid, fumaric acid, malic acid, citric acid, dodecanedioic acid, dimerized fatty acids, hydrogenated dimerized fatty acids, and Elevance Inherent® C18 diacid; and polymer-type di-carboxylic acids including at least one of polyester di-carboxylic acids, polyamide di-carboxylic acids, polyether di-carboxylic acids, and polycarbonate di-carboxylic acids.

In accordance with any of the embodiments, the epoxidized plant-based oils include epoxidized soybean oil Vikoflex® 7170.

In accordance with any of the embodiments, the epoxidized plant-based oils include epoxidized linseed oil selected from Vikoflex® 7190 and EPOXOL® 9-5™.

In accordance with any of the embodiments, the plant-derived epoxides are epoxidized modified plant-based oils including epoxidized propylene glycol dioleate selected Vikoflex® 5075 and sucrose soyate Sefose®.

In accordance with any of the embodiments, the one or more naturally derived epoxides include epoxidized modified plant-based oils, wherein the epoxidized modified plant-based oils include a first oil with a degree of epoxy functionality below 2.5 and a second oil with a degree of epoxy functionality above 6.

In accordance with any of the embodiments, the first oil is epoxidized propylene glycol dioleate and the second oil is epoxidized sucrose soyate.

In accordance with any of the embodiments, the naturally derived epoxides include naturally-based glycidyl-ether-type epoxies, wherein the naturally-based glycidyl-ether-type epoxies is formed by reacting plant-based multiple functional alcohol with 100% bio-based epichlorohydrin, wherein the plant-based multiple functional alcohol is selected from glycerol, sorbitol, isosorbide, and propanediol.

In accordance with any of the embodiments, the naturally-based glycidyl-ether-type epoxies is selected from DENACOL™ GEX-313, GEX-521, GEX-622, BRIOZEN® RD 124 G, and BRIOZEN® RD 135 G.

In accordance with any of the embodiments, the naturally derived epoxides include naturally-based glycidyl-ester-type epoxies, wherein the naturally-based glycidyl-ester-type epoxies is formed by a process of reacting plant-based multiple functional carboxylic acid with 100% bio-based epichlorohydrin, wherein the plant-based multiple functional carboxylic acid can be selected from dimer acids and sebacic acid.

In accordance with any of the embodiments, the naturally-based glycidyl-ester-type epoxies include BRIOZEN® RD 133 G.

In accordance with any of the embodiments, the one or more polyfunctional carboxylic acids includes a polyester di-carboxylic acid formed by reacting a polyester polyol with one or more di-carboxylic acid monomers.

In accordance with any of the embodiments, the one or more polyfunctional carboxylic acids includes a polyamide di-carboxylic acid formed from diamines generated by a bio-fermentation process.

In accordance with any of the embodiments, the one or more polyfunctional carboxylic acids includes a polyamide di-carboxylic acid formed from diamines generated by a bio-industrial process.

In accordance with any of the embodiments, the one or more polyfunctional carboxylic acids includes branched polycarboxylic acids or hyperbranched polycarboxylic acids.

In accordance with any of the embodiments, the branched polycarboxylic acids or hyperbranched polycarboxylic acids are prepared by reacting multifunctional carboxylic acids monomers, or multifunctional alcohols monomers, or multifunctional amines monomers in the polymerization.

In accordance with any of the embodiments, the one or more polyfunctional carboxylic acids are naturally derived polyfunctional carboxylic acids and not naturally occurring polyfunctional carboxylic acids.

In accordance with any of the embodiments, the coating of the flexible construct further comprises one or more catalyst that enables thermal curing of the coating.

In accordance with any of the embodiments, the one or more catalyst is an amine, phosphonium or metal type catalyst with a weight loading ratio of 0.5-3%.

In accordance with any of the embodiments, the one or more catalyst includes at least one of Dabco® 33-LV, NACURE XC-2007, K-PURE CXC-1765 or CYPHOS® IL 169.

In accordance with any of the embodiments, the liquid formula further comprises one or more fillers and additives.

In accordance with any of the embodiments, the one or more fillers are a fume-silica type with a weight loading ratio of 0.3-3%.

In accordance with any of the embodiments, the coating created by the process is characterized by a tensile elongation strain of 250% or greater, 350% or greater, or 550% or greater.

In one embodiment, an article is made by a process of combining one or more naturally derived epoxides and one or more naturally derived polyfunctional carboxylic acids to obtain a mixture, wherein the materials are plant-based; combining the mixture with a solvent to create a liquid formula; coating the liquid formula on a fabric backing; and curing the liquid formula to form a coating on the fabric backing.

In accordance with any of the embodiments, the article includes one or more plant-based pigments and dyes.

In accordance with any of the embodiments, the weight percent of plant-based carbon content in the coating is above 96%.

In accordance with any of the embodiments, the one or more naturally derived epoxides are epoxidized plant-based oils selected from: epoxidized canola oil, epoxidized corn oil, epoxidized linseed oil, epoxidized grape seed oil, epoxidized hemp seed oil, epoxidized olive oil, epoxidized peanut oil, epoxidized sesame oil, epoxidized soybean oil, epoxidized walnut oil, epoxidized sunflower oil, epoxidized high oleic canola oil, epoxidized high oleic sunflower oil, and epoxidized high oleic soybean oil.

In accordance with any of the embodiments, the one or more polyfunctional carboxylic acids is selected from: monomer-type di-carboxylic acids including at least one of azelaic acid, sebacic acid, aconitic acid, a-keto glutaric acid, tartaric acid, fumaric acid, malic acid, citric acid, dodecanedioic acid, dimerized fatty acids, hydrogenated dimerized fatty acids, and Elevance Inherent® C18 diacid; and polymer-type di-carboxylic acids including at least one of polyester di-carboxylic acids, polyamide di-carboxylic acids, polyether di-carboxylic acids, and polycarbonate di-carboxylic acids.

In accordance with any of the embodiments, the epoxidized plant-based oils include epoxidized soybean oil Vikoflex® 7170.

In accordance with any of the embodiments, the epoxidized plant-based oils include epoxidized linseed oil selected from Vikoflex® 7190 and EPOXOL® 9-5™.

In accordance with any of the embodiments, the plant-derived epoxides are epoxidized modified plant-based oils including epoxidized propylene glycol dioleate selected Vikoflex® 5075 and sucrose soyate Sefose®.

In accordance with any of the embodiments, the one or more naturally derived epoxides include epoxidized modified plant-based oils, wherein the epoxidized modified plant-based oils include a first oil with a degree of epoxy functionality below 2.5 and a second oil with a degree of epoxy functionality above 6.

In accordance with any of the embodiments, the first oil is epoxidized propylene glycol dioleate and the second oil is epoxidized sucrose soyate.

In accordance with any of the embodiments, the naturally derived epoxides include naturally-based glycidyl-ether-type epoxies, wherein the naturally-based glycidyl-ether-type epoxies is formed by reacting plant-based multiple functional alcohol with 100% bio-based epichlorohydrin, wherein the plant-based multiple functional alcohol is selected from glycerol, sorbitol, isosorbide, and propanediol.

In accordance with any of the embodiments, the naturally-based glycidyl-ether-type epoxies is selected from DENACOL™ GEX-313, GEX-521, GEX-622, BRIOZEN® RD 124 G, and BRIOZEN® RD 135 G.

In accordance with any of the embodiments, the naturally derived epoxides include naturally-based glycidyl-ester-type epoxies, wherein the naturally-based glycidyl-ester-type epoxies is formed by a process of reacting plant-based multiple functional carboxylic acid with 100% bio-based epichlorohydrin, wherein the plant-based multiple functional carboxylic acid can be selected from dimer acids and sebacic acid.

In accordance with any of the embodiments, the naturally-based glycidyl-ester-type epoxies include BRIOZEN® RD 133 G.

In accordance with any of the embodiments, the one or more polyfunctional carboxylic acids includes a polyester di-carboxylic acid formed by reacting a polyester polyol with one or more di-carboxylic acid monomers.

In accordance with any of the embodiments, the one or more polyfunctional carboxylic acids includes a polyamide di-carboxylic acid formed from diamines generated by a bio-fermentation process.

In accordance with any of the embodiments, the one or more polyfunctional carboxylic acids includes a polyamide di-carboxylic acid formed from diamines generated by a bio-industrial process.

In accordance with any of the embodiments, the one or more polyfunctional carboxylic acids includes branched polycarboxylic acids or hyperbranched polycarboxylic acids.

In accordance with any of the embodiments, the branched polycarboxylic acids or hyperbranched polycarboxylic acids are prepared by reacting multifunctional carboxylic acids monomers, or multifunctional alcohols monomers, or multifunctional amines monomers in the polymerization.

In accordance with any of the embodiments, the one or more polyfunctional carboxylic acids are naturally derived polyfunctional carboxylic acids and not naturally occurring polyfunctional carboxylic acids.

In accordance with any of the embodiments, the article further comprises one or more catalyst that enables thermal curing of the coating.

In accordance with any of the embodiments, the one or more catalyst is an amine, phosphonium or metal type catalyst with a weight loading ratio of 0.5-3%.

In accordance with any of the embodiments, the one or more catalyst includes at least one of Dabco® 33-LV, NACURE XC-2007, K-PURE CXC-1765 or CYPHOS® IL 169.

In accordance with any of the embodiments, the article further comprises one or more fillers and additives.

In accordance with any of the embodiments, the one or more fillers are a fume-silica type with a weight loading ratio of 0.3-3%.

In accordance with any of the embodiments, the article created by the process is characterized by a tensile elongation strain of 250% or greater, 350% or greater, or 550% or greater.

In one embodiment, a plant-based foam comprising a combination of polymerized materials selected from: (i) one or more naturally derived epoxides; (ii) one or more naturally derived polyfunctional carboxylic acids; and (iii) a blowing agent; wherein a weight percent of plant derived carbon in the coating is at least 82%.

In accordance with any of the embodiments, the blowing agent is selected from baking soda (sodium bicarbonate), potassium bicarbonate, azodicarbonamide, and sulfonyl hydrazide.

In accordance with any of the embodiments, the plant-based foam includes one or more plant-based pigments and dyes.

In accordance with any of the embodiments, the weight percent of plant-based carbon content in the coating is above 96%.

In accordance with any of the embodiments, the one or more naturally derived epoxides are epoxidized plant-based oils selected from: epoxidized canola oil, epoxidized corn oil, epoxidized linseed oil, epoxidized grape seed oil, epoxidized hemp seed oil, epoxidized olive oil, epoxidized peanut oil, epoxidized sesame oil, epoxidized soybean oil, epoxidized walnut oil, epoxidized sunflower oil, epoxidized high oleic canola oil, epoxidized high oleic sunflower oil, and epoxidized high oleic soybean oil.

In accordance with any of the embodiments, the one or more polyfunctional carboxylic acids is selected from: monomer-type di-carboxylic acids including at least one of azelaic acid, sebacic acid, aconitic acid, a-keto glutaric acid, tartaric acid, fumaric acid, malic acid, citric acid, dodecanedioic acid, dimerized fatty acids, hydrogenated dimerized fatty acids, and Elevance Inherent® C18 diacid; and polymer-type di-carboxylic acids including at least one of polyester di-carboxylic acids, polyamide di-carboxylic acids, polyether di-carboxylic acids, and polycarbonate di-carboxylic acids.

In accordance with any of the embodiments, the epoxidized plant-based oils include epoxidized soybean oil Vikoflex® 7170.

In accordance with any of the embodiments, the epoxidized plant-based oils include epoxidized linseed oil selected from Vikoflex® 7190 and EPOXOL® 9-5™.

In accordance with any of the embodiments, the plant-derived epoxides are epoxidized modified plant-based oils including epoxidized propylene glycol dioleate selected Vikoflex® 5075 and sucrose soyate Sefose®.

In accordance with any of the embodiments, the one or more naturally derived epoxides include epoxidized modified plant-based oils, wherein the epoxidized modified plant-based oils include a first oil with a degree of epoxy functionality below 2.5 and a second oil with a degree of epoxy functionality above 6.

In accordance with any of the embodiments, the first oil is epoxidized propylene glycol dioleate and the second oil is epoxidized sucrose soyate.

In accordance with any of the embodiments, the naturally derived epoxides include naturally-based glycidyl-ether-type epoxies, wherein the naturally-based glycidyl-ether-type epoxies is formed by reacting plant-based multiple functional alcohol with 100% bio-based epichlorohydrin, wherein the plant-based multiple functional alcohol is selected from glycerol, sorbitol, isosorbide, and propanediol.

In accordance with any of the embodiments, the naturally-based glycidyl-ether-type epoxies is selected from DENACOL™ GEX-313, GEX-521, GEX-622, BRIOZEN® RD 124 G, and BRIOZEN® RD 135 G.

In accordance with any of the embodiments, the naturally derived epoxides include naturally-based glycidyl-ester-type epoxies, wherein the naturally-based glycidyl-ester-type epoxies is formed by a process of reacting plant-based multiple functional carboxylic acid with 100% bio-based epichlorohydrin, wherein the plant-based multiple functional carboxylic acid can be selected from dimer acids and sebacic acid.

In accordance with any of the embodiments, the naturally-based glycidyl-ester-type epoxies include BRIOZEN® RD 133 G.

In accordance with any of the embodiments, the one or more polyfunctional carboxylic acids includes a polyester di-carboxylic acid formed by reacting a polyester polyol with one or more di-carboxylic acid monomers.

In accordance with any of the embodiments, the one or more polyfunctional carboxylic acids includes a polyamide di-carboxylic acid formed from diamines generated by a bio-fermentation process.

In accordance with any of the embodiments, the one or more polyfunctional carboxylic acids includes a polyamide di-carboxylic acid formed from diamines generated by a bio-industrial process.

In accordance with any of the embodiments, the one or more polyfunctional carboxylic acids includes branched polycarboxylic acids or hyperbranched polycarboxylic acids.

In accordance with any of the embodiments, the branched polycarboxylic acids or hyperbranched polycarboxylic acids are prepared by reacting multifunctional carboxylic acids monomers, or multifunctional alcohols monomers, or multifunctional amines monomers in the polymerization.

In accordance with any of the embodiments, the one or more polyfunctional carboxylic acids are naturally derived polyfunctional carboxylic acids and not naturally occurring polyfunctional carboxylic acids.

In accordance with any of the embodiments, the plant-based foam further comprises one or more catalyst that enables thermal curing of the coating.

In accordance with any of the embodiments, the one or more catalyst is an amine, phosphonium or metal type catalyst with a weight loading ratio of 0.5-3%.

In accordance with any of the embodiments, the one or more catalyst includes at least one of Dabco® 33-LV, NACURE XC-2007, K-PURE CXC-1765 or CYPHOS® IL 169.

In accordance with any of the embodiments, the plant-based foam further comprises one or more fillers and additives.

In accordance with any of the embodiments, the one or more fillers are a fume-silica type with a weight loading ratio of 0.3-3%.

In accordance with any of the embodiments, the plant-based foam is characterized by a tensile elongation strain of 250% or greater, 350% or greater, or 550% or greater.

### 4. BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

These and other features, aspects, and advantages of the present invention will become better understood with regard to the following description, and accompanying drawings, where:

FIG. 1 illustrates a leather alternative construct with a black-pigmented topcoat on a bamboo fabric backing, according to an embodiment.

FIG. 2 illustrates a plant-based foam formed from a formulation for the plant-based coating and a blowing agent, according to an embodiment.

### 5. DETAILED DESCRIPTION

### 5.1. Definitions

The term “bio-based” or “biobased” is used throughout to refer to materials or chemicals that are derived from renewable biomass or bio-fermented products instead of petroleum.

The term “degree of functionality” refers to the number of functional groups or bonding sites in a monomer or molecule for bonding.

### 5.2. Coatings

An aspect of the present disclosure is the provision of plant-based elastomeric coatings comprising a combination of polymerized materials selected from one or more naturally derived epoxies; and one or more naturally derived polyfunctional carboxylic acid, wherein the materials are essentially plant-based.

In certain embodiments, the plant-based supple and durable topcoats are formed by reacting naturally derived epoxies with naturally derived polyfunctional carboxylic acid. In one embodiment, a coating with good mechanical elongation properties and supple haptics is achieved through synthesis and formulation of new naturally derived epoxies, and new naturally derived polyfunctional carboxylic acids.

Plant-based coatings, and in particular, plant-based topcoats described herein have in some embodiments, at least 80% plant-carbon content, in some embodiments, at least 90% plant-carbon content, in some embodiments, at least 95% plant-carbon content as calculated from formula inputs or evaluated using ASTM D6866 14C methods.

In certain embodiments, the composition is in the form of a topcoat. In one embodiment, the topcoat described herein is a coating that is applied to flexible substrates. In one embodiment, a flexible substrate can include woven/knitted/non-woven fabric, cloth, paper sheet, plastic film, metal foil/mesh, animal hide leather, wood veneer, mushroom-based textile, or other types of backing textiles to protect the textile from abrasions and wear. In one embodiment, the topcoat gives the material a waterproof protective layer and is a clear coating. In one embodiment, the topcoat described herein has a thickness of 25-450 m.

In alternative embodiments, while the plant-based coatings are primarily engineered for vegan leather topcoats, they are readily reformulated for other topcoat applications, particularly for flexible substrates such as papers or thin metal foils, but more broadly for applications such as automotive exterior coatings, furniture coatings, aerospace coatings, roof coatings, architecture coatings by masters of the art.

In certain embodiments, naturally derived epoxies and the naturally derived polyfunctional carboxylic acids are combined to form a prepolymer blend for coating an article, such as a 100% plant-based fabric, wherein the prepolymer blend is cured to form a topcoat. In certain embodiments, the prepolymer blend further comprises a catalyst.

In various aspects of the present disclosure, the naturally derived epoxies and naturally derived polyfunctional carboxylic acids are selected from any of the class of monomers/oligomers described in sections 5.5.1 and 5.5.2, and are combined with any appropriate mixing ratio.

In some embodiments, the coating disclosed herein is characterized by a range of elongation to break strain of 250% or greater, 350% or greater, or 550% or greater.

In some embodiments, the coating does not include epoxidized natural rubber as described in U.S. Pat. No. 10,400,061 (issued Sep. 3, 2019), U.S. Pat. No. 11,396,578 (issued Jul. 26, 2022), and U.S. Patent App. Pub. No. 2021/0130541 (published May 6, 2021), all of which are hereby incorporated by reference in their entirety. In some embodiments, the coating includes epoxidized natural rubber. In particular embodiments, the coating includes epoxidized natural rubber for use as an enforcement agent.

### 5.3. Flexible Substrate Construct

In one embodiment, a flexible substrate construct is formed by applying the coating described herein to flexible substrates. In one instance, a flexible substrate includes woven/knitted/non-woven fabric, cloth, paper sheet, plastic film, metal foil/mesh, animal hide leather, wood veneer, mushroom-based textile or other types of backing textiles to protect the material from abrasions and wear. In one embodiment, the backing textile for synthetic leather construction includes plant-based fabrics or recycled-plastic based fabrics. In some embodiments, plant-based fabrics include but are not limited to organic cotton, linen, seaweed, bamboo fabrics. In some embodiments, the backing textile also includes certain blends with fibers derived from agriculture wastes. In some embodiments, recycled-plastic based fabrics include recycled (polyethylene terephthalate) (rPET). Depending on the application, the fabric is weaved, knitted or non-woven. In particular embodiments, the flexible substrate construct is formulated with the naturally derived epoxies and naturally derived carboxylic acids described in section 5.5Error! Reference source not found. In a particular embodiment, the flexible substrate construct is formed by applying a topcoat of Formulations 1 to 5 on a plant-based backing textile.

### 5.4. Plant-Based Foam

While the compositions described in the sections above are described in conjunction with plant-based supple and durable topcoats, in certain embodiments, the compositions are modified to make plant-based foam. In one embodiment, the compositions for the plant-based coating are mixed with an amount of thermally induced blowing agent to prepare the plant-based foam. The blowing agent includes, but is not limited to, baking soda (sodium bicarbonate), potassium bicarbonate, azodicarbonamide, and sulfonyl hydrazides.

### 5.5. Prepolymer Materials

In an aspect of the present disclosure, one or more of the materials used to produce the provided coatings are derived from renewable resources such as biomass. In some embodiments, the materials are derived from plants, i.e., are based on materials obtained from renewable sources. For example, the materials may be derived from wood and wood processing wastes, agricultural crops and waste materials, biogenic materials, and the like.

### 5.5.1. Naturally Derived Epoxides

In an aspect of the present disclosure, one or more naturally derived epoxides are included in the composition for coating. In some embodiments, the naturally derived epoxide is derived from epoxidized plant-based oil mixtures. In some embodiments, the naturally derived epoxide comprises at least 2 epoxide functional groups, at least 3 epoxide functional groups, at least 4 epoxide functional groups, or at least 5 epoxide functional groups.

A general depiction of epoxide monomers is shown in Formula, in accordance with one or more embodiments. The left formula depicts a monomer with internal epoxides, such as (but not limited to) those found in epoxidized vegetable oils. The right formula depicts a glycidyl ether type epoxide monomer. In one embodiment, n, m can each be an integer greater than 0, greater than 1, greater than 2, greater than 3, greater than 4, greater than 5, greater than 6, greater than 7, and greater than 8, greater than 9, greater than 10, greater than 11, greater than 12. In one embodiment, R1, R2, and R can each be selected from the materials described in section 5.5.1 below. For example, each of R1, R2, and R can be obtained from fatty acid molecules from plant-based oils (e.g., soybean, linseed), glycidyl-ether, glycidyl-ester, propylene glycol dioleate, sucrose soyate.

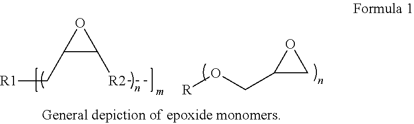

In some embodiments, the naturally derived epoxide includes epoxidized plant-based oils that are triesters including a glycerol bound to three fatty acid molecules and one or more epoxy rings that are converted from unsaturated carbon double bonds in the fatty acid molecules. In some embodiments, the naturally derived epoxide includes epoxidized modified plant-based oils. As defined herein, the epoxidized modified plant-based oils refer to reconstructed products of fatty acids. In particular embodiments, the epoxidized modified plant-based oils are obtained by hydrolysis of triglyceride and reacted with a multiple functional alcohol that is not glycerol.

In some embodiments, naturally derived epoxies include naturally-based glycidyl-ether-type epoxies. In one embodiment, such epoxies are obtained by reacting a plant-based multiple functional alcohol with 100% bio-based epichlorohydrin.

In some embodiments, naturally derived epoxies include naturally-based glycidyl-ester-type epoxies. In one embodiment, such epoxies are obtained by reacting a plant-based multiple functional carboxylic acid with 100% bio-based epichlorohydrin.

Plant-based oils are a mixture of triglycerides. Glycerides are esters of the three-carbon alcohol glycerol and fatty acids. Glycerol has three hydroxyl groups per molecule and thus is described as a polyhydric alcohol. A glyceride is a monoglyceride, diglyceride, and triglyceride depending on whether one, two, or three of the alcohol groups of glycerol are esterified with fatty acid(s). As listed in Table 1, depending on the type of the plant-based oil, the plant-based oils have different ratios among these three different glycerides: saturated; monounsaturated; and polyunsaturated. A saturated triglyceride is one whose carbon chains are composed of carbon-carbon single bonds. An unsaturated triglyceride is one whose carbon chains include one or more carbon-carbon double bonds. A triglyceride with one double bond is monounsaturated, while a triglyceride with multiple double bonds is polyunsaturated.

While monounsaturated and polyunsaturated glycerides provide reaction sites for chemical modification and crosslinking, saturated ones will not be able to react, and will exist as dangling side-chains in the eventually cured networks, thereby weakening the cured topcoats. Thus, to achieve durable topcoats, it is desirable to use plant-based oils that are low in saturated glycerides. In certain embodiments, plant-based oils with less than 20% saturated glycerides are used for the composition for coatings described herein. In certain other embodiments, it is preferred to use plant-based oils with less than 10% saturated glycerides.

While plant-based oils containing unsaturated groups can participate in thiol-ene reaction or Diels-Alder reaction to polymerize or crosslink into topcoats, in some embodiments, it is more desirable to first convert them in epoxies through an oxidation reaction. This can yield a vast design space for topcoat formulations and processing. Epoxidized plant-based oils are commercially available from bio-industrial sectors, e.g., Cargill Vikoflex® 7170, Vikoflex® 7190, or ACS Technical Products EPOXOL® 9-5.

TABLE 1
Plant-based oils and their composition.

| Type | Saturated | Monounsaturated | Polyunsaturated |
|---|---|---|---|
| Canola | 7.4 | 63.3 | 28.1 |
| Corn | 12.9 | 27.6 | 54.7 |
| Linseed | 9 | 18.4 | 67.8 |
| Grape seed | 10.5 | 14.3 | 74.7 |
| Hemp seed | 7 | 9 | 82 |
| Olive | 13.8 | 73 | 10.5 |
| Peanut | 16.2 | 57.1 | 19.9 |
| Sesame | 14.2 | 39.7 | 41.7 |
| Soybean | 15.6 | 22.8 | 57.7 |
| Walnut oil | 9.1 | 22.8 | 63.3 |
| Sunflower | 8.99 | 63.4 | 20.7 |

In some embodiments, the epoxidized plant-based oils for forming the coating described herein include plant-based soybean oils, linseed oils, canola oils, corn oils, grape seed oils, hemp seed oils, olive oils, peanut oils, sesame oils, walnut oils, sunflower oils, or a combination thereof.

In terms of physical properties, the viscosity, acid value, iodine value, and oxirane value of the epoxidized plant-based oil are important parameters among others. The viscosity is a parameter to be considered during production, transportation, and storage, and generally increases with higher molecular weight. The acid value is a chemical measurement which represents the acidity of the fatty acid calculated from the mass of base material used to neutralize the acid, and in one embodiment, the total acid value is determined by the amount of potassium hydroxide (KOH) in milligrams (mg) required to neutralize the acid in one gram of fatty acid. The iodine value provides insight of the reactivity and degree of unsaturation of the fatty acids. The iodine value is measure of the number of double bonds and in one embodiment, is given by the number of grams of iodine absorbed by 100 g of fat. The oxirane value is an indication of the percentage content of epoxide group. The quality of the epoxidized oil is generally better with higher oxirane value and lower iodine value.

### 5.5.1.1.1 Epoxidized Oils Derived from Soybean Oils

Epoxidized soybean oils are organic compounds obtained from the epoxidation of soybean oil. The oils are used as a plasticizer and stabilizer in PVC plastics.

In certain embodiments, the epoxidized plant-based oil is derived from soybean oils. In one embodiment, the epoxidized soybean oil is Vikoflex® 7170 from Cargill. Vikoflex® 7170 has relatively high oxirane efficiency from specially processed soybean oil and produces good compatibility and stabilization performance. The physical properties of Vikoflex® 7170 are described in Table 2 below.

TABLE 2
Physical properties of Vikoflex ® 7170.
Typical Physical Properties

| Oxirane Oxygen | 6.8% | Min |
|---|---|---|
| Specific Gravity 25/25° C. | 0.993 | |
| Color - APHA | 150 | Max |
| Pounds Per Gallon @ 25° C. | 8.3 | |
| Viscosity Stokes @ 25° C. | 4.2 | |
| Acid Value | 0.5 | Max |
| Molecular Weight | 1000 | |
| Freeze Point | 0° | C. |
| Fire Point | 315° | C. |
| Refractive Index @ 25° C. | 1.472 | |
| Odor | Mild | |
| Iodine Value | 2 | Max |

i. Bio-Content

In some embodiments, the epoxidized plant-based oils are obtained from biomass. In some embodiments, when the epoxidized plant-based oils are derived from soybean oils, the bio-content is 100%.

ii. Mol. Weight (g/Mol)

In some embodiments, when the epoxidized plant-based oils are derived from soybean oils, the molecular weight is approximately 975.

iii. Degree of Functionality

In some embodiments, when the epoxidized plant-based oils are derived from soybean oils, the degree of functionality is within the range of 4.1-4.5.

iv. Oxirane Oxygen (%)

In some embodiments, when the epoxidized plant-based oils are derived from soybean oils, the oxirane oxygen percent is within the range of above 6.8%.

v. Iodine Value (g of I₂/100 g)

In some embodiments, when the epoxidized plant-based oils are derived from soybean oils, the iodine value is within the range of 0-2.

vi. Acid Value (mg KOH/g)

In some embodiments, when the epoxidized plant-based oils are derived from soybean oils, the acid value is within the range of 0-0.5.

### 5.5.1.1.2 Epoxidized Oils Derived from Linseed Oils

Epoxidized linseed oils are organic compounds obtained from the epoxidation of linseed oil. The oils are used as a plasticizer and stabilizer in PVC plastics.

In certain embodiments, the epoxidized plant-based oil is derived from linseed oils. In one embodiment, the epoxidized linseed oil is Vikoflex® 7190 from Cargill. Vikoflex® 7190 has relatively high compatibility and superior heat and light stability performance. The physical properties of Vikoflex® 7190 are described in Table 3 below.

TABLE 3
Physical properties of Vikoflex ® 7190.
Typical Physical Properties

| Oxirane Oxygen | 9.0% | Min |
|---|---|---|
| Acid Value | 0.5 | Max |
| Specific Gravity 25/25° C. | 1.03 | |
| Refractive Index @ 25° C. | 1.4765 | |
| Color - APHA | 225 | Max |
| Fire Point | 343° | C. |
| Pounds Per Gallon @ 25° C. | 8.58 | |
| Odor | Very Low | |
| Viscosity @ 25° C. | 650 | cps Min |
| Iodine | 3.5 | Max |

In certain embodiments, the epoxidized linseed oil is selected from EPOXOL® 9-5™ from ACS Technical Products, Inc. EPOXOL® 9-5™ has high oxirane that makes it suitable for applications where high oxirane levels are required because of formula restrictions. The physical properties of EPOXOL® 9-5™ are described in Table 4 below.

TABLE 4
Physical properties of EPOXOL ® 9-5 ™.

| Properties | Typical Value |
|---|---|
| Oxirane Oxygen (wt. %) | 9.3 |
| Acid Number (mg KOH/g) | 0.08 |
| Peroxide Value (meq/Kg) | 7 |
| Color (APHA) | 100 |
| Specific Gravity (25° C.) | 1.030 |
| Viscosity (cps at 25° C.) | 750 |
| Flash Point (COC, ° F.) | 600 |
| Refractive Index | 1.475 |

i. Bio-Content

In some embodiments, the epoxidized plant-based oils are obtained from biomass. In some embodiments, when the epoxidized plant-based oils are derived from linseed oils, the bio-content is within the range of 100%.

ii. Mol. Weight (g/Mol)

In some embodiments, when the epoxidized plant-based oils are derived from linseed oils, the molecular weight is around 980.

iii. Degree of Functionality

In some embodiments, when the epoxidized plant-based oils are derived from linseed oils, the degree of functionality is within the range of 6.5-6.8.

iv. Oxirane Oxygen (%)

In some embodiments, when the epoxidized plant-based oils are derived from linseed oils, the oxirane oxygen percent is within the range of 8.9-9.3.

v. Iodine Value (g of I₂/100 g)

In some embodiments, when the epoxidized plant-based oils are derived from linseed oils, the iodine value is within the range 0-3.5.

vi. Acid Value (Mg KOH/g)

In some embodiments, when the epoxidized plant-based oils are derived from linseed oils, the acid value is within the range 0-0.5.

### 5.5.1.2 Epoxidized Modified Plant-Based Oils

In certain embodiments, the plant-based epoxides include epoxidized modified plant-based oils. In some embodiments, the epoxidized modified plant-based oils is a bifunctional epoxidized modified plant-based oil with two epoxide functional groups. In some embodiments, the epoxidized modified plant-based oils include at least 2 epoxide functional groups, at least 3 epoxide functional groups, or at least 4 epoxide functional groups.

In certain embodiments, the epoxidized modified plant-based oils are reconstructed products of fatty acids. In particular embodiments, the epoxidized modified plant-based oils are obtained by hydrolysis of triglyceride and reacted with a multiple functional alcohol that is not glycerol.

### 5.5.1.2.1 Epoxidized Propylene Glycol Dioleate

In certain embodiments, the epoxidized modified plant-based oils include epoxidized propylene glycol dioleate. Propylene glycol dioleate is a diester of propylene glycol and oleic acid. In certain embodiments, the propylene glycol dioleate is derived from renewable resources, such as epoxidized linseed oil, soybean and tall oil fatty acid esters for applications such as PVC plasticization, acid and mercaptan scavenging, specialty coatings, adhesives & urethanes, reactive diluents, PU flexible foam and intermediates for surfactants and lube & fuel additives.

Fully epoxidized plant-based oils tend to have a degree of functionality larger than 2.8, and thereby leading to a highly crosslinked polymer network. To achieve high elongation to break strain, it is desirable to also include, in the composition for topcoat formula, epoxidized modified plant-based oils with a lower degree of functionality in the formulation. One such epoxidized modified plant-based oil having a degree of functionality of 2 is epoxidized propylene glycol dioleate. In certain embodiments, the epoxidized propylene glycol dioleate is Vikoflex® 5075 from Cargill. Vikoflex® 5075 has relatively low volatility, low temperature flexibility and high compatibility in polyvinyl chloride systems. The physical properties of Vikoflex® 5075 are described in Table 5 below.

TABLE 5
Physical properties of Vikoflex ® 5075.
Typical Physical Properties

| Oxirane Oxygen | 4.4% | Min |
|---|---|---|
| Acid Value | 1.0 | Max |
| Viscosity Stokes @ 25° C. | 1.2 | |
| Color - APHA | 175 | Max |
| Refractive Index @ 25° C. | 1.4765 | |
| Flash Point | <500° | F. |
| Freeze Point | 32° | F. |

i. Bio-Content

In some embodiments, the epoxidized modified plant-based oils are obtained from biomass. In some embodiments, when the epoxidized modified plant-based oil is epoxidized propylene glycol dioleate, the bio-content is within the range of 92-100%.

ii. Mol. Weight (g/Mol)

In some embodiments, when the epoxidized modified plant-based oil is epoxidized propylene glycol dioleate, the molecular weight is around 575.

iii. Degree of Functionality

In some embodiments, when the epoxidized modified plant-based oil is epoxidized propylene glycol dioleate, the degree of functionality is 2.

iv. Oxirane Oxygen (%)

In some embodiments, when the epoxidized modified plant-based oil is epoxidized propylene glycol dioleate, the oxirane oxygen percent is within the range 4.4-4.7.

v. Iodine Value (g of I₂/100 g)

In some embodiments, when the epoxidized modified plant-based oil is epoxidized propylene glycol dioleate, the iodine value is within the range of 0-2.

vi. Acid Value (mg KOH/g)

In some embodiments, when the epoxidized modified plant-based oil is epoxidized propylene glycol dioleate, the acid value is within the range 0-1.

### 5.5.1.2.2 Epoxidized Sucrose Soyate

In certain embodiments, it is worthy of including a certain high degree of epoxidized modified plant-based oil. One such example is epoxidized sucrose soyate. Sucrose soyate is modified from soybean oil, and is produced commercially by Proctor and Gamble under the trade name of SEFOSE. A simple oxidation process can convert sucrose soyate into epoxidized sucrose soyate with a degree of functionality larger than 7. High degree of functionality leads to high crosslinking density, high modulus and good scratch resistance. In one embodiment, the oxidation process is described in He et al., “Epoxidation of Soybean Oil by Continuous Micro-Flow System with Continuous Separation,” Org. Process Res. Dev. 2013, 17, 9, 1137-1141.

In some embodiments, the epoxidized modified plant-based oil is epoxidized sucrose soyate (ESS). As described above, epoxidized ESS is formed by performing an oxidation reaction process to sucrose soyate. In one embodiment, the sucrose soyate is selected from Sefose® from Proctor & Gamble (P&G). Sefose® is a sucrose fatty acid ester made from soybean oil (soyate) and is a viable alternative to glycerin-based oils. Sefose® is highly esterified sucrose polyester made from sugar and soybean oils and includes a sucrose backbone and natural fatty acid residues linked to sucrose through ester bonds. This higher functionality of fatty chains can provide increased hydrophobicity for water resistance, higher crosslink density and faster drying than glycerin-based oils.

i. Bio-Content

In some embodiments, the epoxidized modified plant-based oils are obtained from biomass. In some embodiments, when the epoxidized modified plant-based oil is sucrose soyate, the bio-content is 100%.

ii. Mol. Weight (g/Mol)

In some embodiments, when the epoxidized modified plant-based oil is epoxidized sucrose soyate, the molecular weight is within the range of 2050-2700.

iii. Degree of Functionality

In some embodiments, when the epoxidized modified plant-based oil is epoxidized sucrose soyate, the degree of functionality is within the range of 8-15.

iv. Oxirane Oxygen (%)

In some embodiments, when the epoxidized modified plant-based oil is epoxidized sucrose soyate, the oxirane oxygen percent is within the range of 6.8-9.6.

v. Iodine Value (g of I₂/100 g)

In some embodiments, when the epoxidized modified plant-based oil is epoxidized sucrose soyate, the iodine value is within the range of 0-3.

vi. Acid Value (mg KOH/g)

In some embodiments, when the epoxidized modified plant-based oil is epoxidized sucrose soyate, the acid value is within the range of 0-1.

In one embodiment, the naturally derived epoxides include a first oil with a degree of epoxy functionality below 2.5 (e.g., glycol dioleate) and a second oil with a degree of epoxy functionality above 6 (e.g., epoxidized sucrose soyate).

### 5.5.1.3 Naturally-Based Glycidyl-Ether/Ester-Type Epoxies

In certain embodiments, the plant-based epoxides include naturally-based glycidyl-ether-type epoxies. In one embodiment, such epoxies can be obtained by reacting a plant-based multiple functional alcohols with 100% bio-based epichlorohydrin. In one embodiment, plant-based functional alcohols include at least one or a combination of glycerol, sorbitol, isosorbide, and Susterra® propanediol, etc. In one embodiment, naturally-based glycidyl-ether-type epoxies can also be made by reacting plant-based polyols with 100% bio-based epichlorohydrin. Such plant-based polyols can include plant-based polyester polyols, e.g. bio-Hoopol polyols from Synthesia Technology Group. Such plant-based polyols can include plant-based polyether polyols, e.g. poly(trimethylene ether) glycols (PO3G) from SK Chemicals Co., Ltd. or WeylChem International GmbH.

In certain embodiments, the plant-based epoxides include naturally-based glycidyl-ester-type epoxies. In one embodiment, the naturally-based glycidyl-ester-type epoxides are obtained by reacting a plant-based multiple functional carboxylic acid with 100% bio-based epichlorohydrin. Such carboxylic acids include dimer acids, and sebacic acid, etc.

One advantage of using naturally-based glycidyl-ether/ester-type epoxies to replace or partially replace plant oil based epoxides is that they are more reactive, thereby allowing for lower curing temperatures and short curing times.

TABLE 6
Physical properties of DENACOL ® ether-type epoxies.

| | | Epoxy | | Biobased |
|---|---|---|---|---|
| | | equivalent | Viscosity | Content |
| Grade | Chemical Description | (g/ed.) | (mPa*2) | (%) |
| GEX-313 | Glycerol Polyglycidyl | 141 | 150 | 100 |
| | Ether | | | |
| GEX-521 | Polyglycerol | 183 | 4,400 | 100 |
| | Polyglycidyl Ether | | | |
| GEX-622 | Sorbitol Polyglycidyl | 191 | 11,800 | 100 |
| GEX-614B | Ether | 173 | 5,000 | 87 |

### 5.5.1.4 Example Plant-Based Epoxides

Table 7 describes examples of epoxidized plant-based oils and a description of the chemical species for each example. In some embodiments, the plant-based oils for the composition included in the coating is selected from Table 7.

TABLE 7
Chemical formula and species of plant-based epoxides.

| Product | Chemical Formula/Species |
|---|---|
| Vikoflex ® 7170 | Epoxidized soybean oil |
| Vikoflex ® 7190 | Expoxidized linseed oil |
| Vikoflex ® 5075 | Epoxidized Propylene Glycol Dioleate |
| | 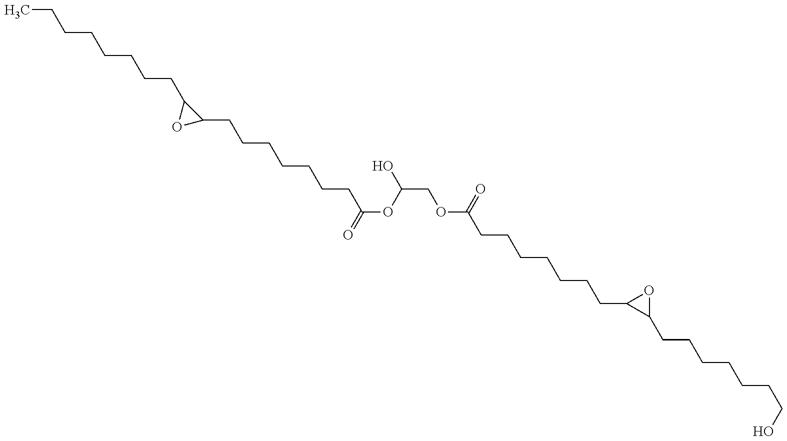 [SMILES: CCCCCCCCC1OC1CCCCCCCC(=O)OC(O)COC(=O)CCCCCCCC1OC1CCCCCCCO] |
| EPOXOL ® 9-5 ™ | Epoxidized linseed oil |
| Sefose ® | Epoxidized sucrose fatty acid ester |

### 5.5.1.5 Example Naturally-Based Glycidyl-Ether/Ester-Type Epoxies

Table 8 describes examples of example naturally-based glycidyl-ether/ester-type epoxies and a description of the chemical species for each example. In some embodiments, naturally-based glycidyl-ether/ester-type epoxies for the composition included in the coating is selected from Table 8.

TABLE 8
Chemical formula and species of naturally-based glycidyl-ether/ester-type
epoxies.

| Product | Chemical Formula/Species |
|---|---|
| DENACOL ™ GEX-313 | Glycerol Polyglycidyl Ether |
| | 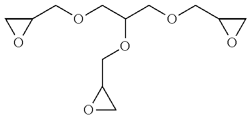 [SMILES: C(OCC1CO1)C(COCC1CO1)OCC1CO1] |
| | (e.g.,) |
| DENACOL ™ GEX-521 | Polyglycerol Polyglycidyl Ether |
| DENACOL ™ GEX-622 | Sorbitol Polyglycidyl Ether |
| BRIOZEN ® RD 124 G | Triglycidyl Ether of Castor Oil |
| BRIOZEN ® RD 133 G | Diglycidyl Ester of Dimer Acid |
| BRIOZEN ® RD 135 G | Diglycidyl Ether of Isosorbide |

In one embodiment, naturally-based glycidyl-ether-type epoxies for the composition included in the coating is made by reacting plant-based poly(trimethylene ether) glycols (PO3G) with at least 80%, at least 85%, at least 90%, at least 95%, or 100% bio-based epichlorohydrin. In some embodiments, the mixing ratio of the PO3G to the epichlorohydrin is within the range of 1:1.95-2.05, more specifically 1:2. In one embodiment, sodium hydroxide catalyst is added into the mixture. As defined herein, the mixing ratio refers to the molar mixing ratio unless specified otherwise. Table 9 illustrates the PO3G-based glycidyl ether in which the mixing ratio of (PO3G) 600 to bio-based epichlorohydrin is 1:2 as an example.

TABLE 9
Synthesis of PO3G-based glycidyl ether.

| | | Mixing ratio |
|---|---|---|
| Reactants | Equivalent weight | by amount |
| poly(trimethylene ether) | 300 | 1 |
| glycols (PO3G) 600 | | |
| 100% bio-based | 92.5 | 2 |
| epichlorohydrin | | |

### 5.5.2. Naturally Derived Polyfunctional Carboxylic Acids

Naturally occurring polyfunctional carboxylic acids include but are not limited to citric acid, malic acid, tartaric acid, malonic acid, succinic acid, fumaric acid, and glutaric acid. A characteristic of polyfunctional carboxylic acids is that they typically have a degree of functionality 2 or 3, and are small in molecular size. Using them as curatives for epoxidized plant-based oils tends to lead to highly crosslinked polymer networks with low tensile elongation to break strains, lacking the supple and durable physical and mechanical properties of leather mimicking topcoats.

A general depiction of polyfunctional carboxylic acid is shown below in Formula 2. In one embodiment, n can be an integer greater than 0, greater than 1, greater than 2, greater than 3, greater than 4, greater than 5, greater than 6, greater than 7, and greater than 8. In one embodiment, R can be selected from the materials described in section 5.5.2 below. For example, R can be obtained from plant-based fatty acids, plant-based polyether, polyester, polyamide (e.g., synthesized from diamines such as hexamethylene diamine or dimer diamine), polycarbonates.

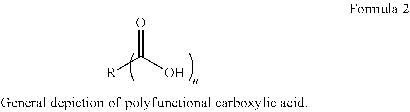

While naturally occurring polyfunctional carboxylic acids are quite limited, the abundant biomolecules in nature include cellulose, lignin, plant-based oils, and sugars. Fragmentation, oxidation, polymerization and other chemical reprocessing processes of these abundant biomolecules can lead to naturally derived polyfunctional carboxylic acids with vast design space of molecular structures, molecular weights and ultimate material properties. At the same time, synthesizing naturally derived polyfunctional carboxylic acids as coating curatives benefits from the abundant availability of renewable raw materials, and thereby has great intrinsic scalability. Certain raw materials to use can be still largely untapped agricultural wastes. In certain embodiments, naturally occurring carboxylic acids refer to acids that are obtained from nature without chemical synthesis steps. For example, citric acid from orange processing. In particular embodiments, a naturally occurring carboxylic acid is obtained from purification and crystallization without chemical synthesis steps.

In some embodiments, the naturally derived polyfunctional carboxylic acids include naturally derived polycarboxylic acid monomers and naturally derived polycarboxylic polymers. In certain embodiments, naturally derived carboxylic acids refer to acids obtained from one or more chemical synthesis steps. To achieve the supple and durable physical and mechanical properties of a leather mimicking topcoats, it is desirable to synthesize di-carboxylic acids with a range of different molecular weights as curatives. A dicarboxylic acid is an organic compound including two carboxyl groups (—COOH).

In some embodiments, di-carboxylic acids include azelaic acid, sebacic acid, dodecanedioic acid, dimerized fatty acids, hydrogenated dimerized fatty acids, Elevance Inherent® C18 diacid. For example, sebacic acid is obtained from castor oil by cleavage of ricinoleic acid. As another example, azelaic acid is obtained from ozonolysis of oleic acid. In some embodiments, these examples are referred to as naturally derived polycarboxylic acid monomers.

In some embodiments, the di-carboxylic acids include polycarboxylic acid polymer resins that are obtained by reacting naturally derived polycarboxylic acid monomers with plant-based polyester, polyether, polyamide, polycarbonate polyols. In particular embodiments, the di-carboxylic acids include polyester di-carboxylic acids, polyamide di-carboxylic acids, polyether di-carboxylic acids, and polycarbonate di-carboxylic acids, which can be polymerized and post-polymerization modified to have 1000 plant-based carbon. The later examples of di-carboxylic acids can be prepared by modifying 100 plant-based diols that are chemical compounds including two hydroxyl groups (—OH). Depending on whether the plant-based diol has a polyester, polyether, polyamide, polycarbonate backbone, plant-based diols are classified into a polyester diol, polyether diol, polyamide diol, or polycarbonate diol.

### 5.5.2.1 Naturally Derived Polyester Di-Carboxylic Acids

In certain embodiments, the naturally derived polyester di-carboxylic acids are synthesized from Bio-Hoopol polyols from Synthesia Technology Group. Bio-Hoopol polyols are green saturated polyester polyols based on acids and/or glycols obtained from renewable sources. In some embodiments, the polyester diol or polyol is selected from Table 10 below. In some embodiments, the polyol is Bio-Hoopol 13003.

TABLE 10
Polyols from BIO-HOOPOL family.

| | BIO content* | OHV | AV | Mol. Weight | Melting Point | Glass Trans. T^{d} | Viscosity | |
|---|---|---|---|---|---|---|---|---|
| BIO-HOOPOL | (%) | (mg KOH/g) | (mg KOH/g) | (g/mol) | (° C.) | (° C.) | (mPa s) | |
| 9110 | >90 | 54-58 | ≤0.4 | 2000 | 33 | — | 2.500 | (40° C.) |
| 9710 | 60-70 | 56-64 | ≤1.5 | 2800 | — | −59 | 25000 | (25° C.) |
| 11003 | 100 | 54-58 | ≤2.0 | 2000 | 45 | — | 2.700-3.700 | (60° C.) |
| 11023 | 100 | 117-123 | ≤0.6 | 1000 | 38 | — | 700 | (60° C.) |
| 11034 | 60-70 | 27-34 | ≤2.0 | 3750 | — | −17 | 1.000-5.000 | (120° C.) |
| 11043 | 100 | 75-85 | ≤0.6 | 1400 | 50 | — | 1.400 | (60° C.) |
| 11053 | 100 | 165-175 | ≤0.6 | 660 | 42 | — | 380 | (60° C.) |
| 11501 | 100 | 54-58 | ≤0.5 | 2000 | 112 | — | 250 | (130° C.) |
| 11503 | 100 | 54-58 | ≤2.0 | 2000 | 57 | — | 650-1.550 | (80° C.) |
| 11520 | 100 | 103-117 | ≤2.0 | 1000 | 104 | — | ~50 | (130° C.) |
| 11531 | 40-50 | 25-32 | ≤2.0 | 4000 | 113 | — | 400-1.600 | (130° C.) |
| 11532 | 100 | 25-32 | ≤2.0 | 4000 | 113 | — | 400-1.600 | (130° C.) |
| 11533 | 100 | 26-32 | ≤2.0 | 3900 | 96 | — | 600 | (130° C.) |
| 11580 | 100 | 37-40 | ≤0.5 | 2900 | 107 | — | 400 | (130° C.) |
| 11900 | >30 | 53-58 | ≤0.5 | 2000 | 48 | — | 1.500 | (60° C.) |
| 11903 | 70-80 | 54-58 | ≤1.0 | 2000 | — | −47 | 2100 | (60° C.) |
| 11904 | 100 | 54-58 | ≤2.0 | 2000 | 23 | — | 1500 | (60° C.) |
| 11929 | >30 | 117-123 | ≤0.6 | 950 | 46 | — | 320 | (60° C.) |
| 12003 | 100 | 54-58 | ≤1.0 | 2000 | 52 | — | 1100 | (60° C.) |
| 12530 | 100 | 27-34 | ≤2.0 | 3750 | 62 | — | 3.000 | (80° C.) |
| 12600 | 30-40 | 50-58 | ≤2.0 | 2000 | — | −21 | 6.500 | (80° C.) |
| 12900 | >50 | 50-59 | ≤2.0 | 2000 | 64 | — | 500 | (80° C.) |
| 12930 | 64 | 27-34 | ≤2.0 | 3750 | 67 | — | 1.000-4.000 | (80° C.) |
| 12970 | >50 | 43-47 | ≤2.0 | 2500 | 70 | — | 1.000 | (80° C.) |
| 13003 | 100 | 54-58 | ≤1.0 | 2000 | — | −51 | 1.900 | (60° C.) |
| 13033 | 100 | 54-58 | ≤1.0 | 3750 | — | −47 | 5.000 | (80° C.) |

In some embodiments, the Bio-Hoopol polyol is reacted with a di-carboxylic acid to be converted into polyester di-carboxylic acids with or without using any catalysts or solvents. In a particular embodiment, Bio-Hoopol 13003 from Synthesia Technology Group, a 100% plant-based polyester diol is reacted with sebacic acid, or another type of di-carboxylic acid to create polyester di-carboxylic acids.

In one embodiment, the mixing ratio of the polyester polyol to the di-carboxylic acid (e.g., sebacic acid) is within the range of 1:1.19-2.1 and specifically, the mixing ratio is within the range of 1:1.95-2.05, more specifically 1:2. In one embodiment, catalysts or solvents are not added into the mixture.

### 5.5.2.1.1 Bio-Content

In some embodiments, the naturally derived di-carboxylic acids are obtained from biomass. In some embodiments, when the naturally derived di-carboxylic acids are polyester di-carboxylic acids, the bio-content is within the range 70-100%.

### 5.5.2.1.2 Degree of Functionality

In some embodiments, when the naturally derived di-carboxylic acids are polyester di-carboxylic acids, the degree of functionality is 2.

### 5.5.2.2 Naturally Derived Polyamide Di-Carboxylic Acids

Bio-fermentation is a rapid-developing biotechnology that uses microorganisms to create new chemicals. In some embodiments, synthesizing naturally derived polyfunctional carboxylic acids use molecules from one or more bio-fermentation processes. In certain embodiments, the naturally derived di-carboxylic acid is a polyamide di-carboxylic acid and is synthesized from diamines generated from a bio-fermentation process. In some embodiments, one such example of diamines generated from a bio-fermentation process is hexamethylene diamine from Genomatica. The hexamethylene diamine reacts with di-carboxylic acid monomers in extra to form polyamide di-carboxylic acid.

Plant-based diamines can also be produced in a bioindustrial process. In some embodiments, naturally derived di-carboxylic acid is a polyamide di-carboxylic acid and is synthesized from diamines produced in a bioindustrial process. In some embodiments, one such example of diamines produced in a bioindustrial process is Priamine™ 1075 dimer diamine from Cargill. The dimer diamine reacts with di-carboxylic acid monomers in extra to form polyamide di-carboxylic acid.

### 5.5.2.2.1 Bio-Content

In some embodiments, the naturally derived di-carboxylic acids are obtained from biomass. In some embodiments, when the naturally derived di-carboxylic acids are polyamide di-carboxylic acids, the bio-content is within the range 80-100%.

### 5.5.2.2.2 Degree of Functionality

In some embodiments, when the naturally derived di-carboxylic acids are polyamide di-carboxylic acids, the degree of functionality is 2.

While the above description has been focused on di-carboxylic acids, in certain embodiments, it is desirable to include branched polycarboxylic acids or even hyperbranched polycarboxylic acids in the formula. Such multifunctional polycarboxylic acids will increase the crosslinking density, and thereby improve on the modulus, strength and abrasion resistance. In some embodiments, the branched polycarboxylic acids or hyperbranched polycarboxylic acids are prepared by reacting multifunctional carboxylic acid monomers, or multifunctional alcohol monomers, or multifunctional amine monomers in the polymerization.

### 5.6. Solvent Systems

Solvent systems are used to coat or cast the composition for the coating described herein. In some embodiments, spray coating or dip coating processes are used. In some embodiments, changing to different solvent systems will be preferred for different coating processes.

The preferred solvents are the solvents on the VOC exempt list. These solvents have low toxicity, and are readily degradable. In certain embodiments, dimethyl carbonate, methyl acetate, tertiary butyl acetate, and propylene carbonate are used alone. In some embodiments, a mixture of 2 above solvents are preferred.

### 5.7. Catalysts

In some embodiments, the composition for the coating described herein further comprises one or more catalysts. Reactions between epoxy resins and carboxylic or anhydride groups are used as a crosslinking mechanism in many industrial powder coating systems. While in some embodiments, the reaction proceeds by thermal curing without a catalyst, the presence of a catalyst including a wide range of amine, phosphonium, and metal catalysts can significantly reduce the curing temperature and increase the curing speed. In certain embodiments, Dabco® 33-LV is used as the catalyst with a weight loading ratio of 0.5-3%. In certain other embodiments, NACURE XC-2007 or K-PURE CXC-1765 is the preferred catalyst with a weight loading ratio of 0.5-3%. In certain other embodiments, CYPHOS® IL 169 is used as the preferred catalyst with a weight loading ratio of 0.5-3%.

In some embodiments, the polymerization proceeds without a catalyst.

It would be understood by a person of ordinary skill that the catalyst system is selected from those known in the art according to the desired temperature or reaction conditions. For example, if low temperature cure or room temperature cure is favored, catalysts selected from this in the art are readily identifiable.

### 5.8. Prepolymer Blend

In one embodiment, the prepolymer blend comprises naturally derived epoxides, such as an epoxidized plant-based oil (one or a combination of oils described in conjunction with section 5.5 Error! Reference source not found.) or naturally-based glycidyl ether/ester-type epoxies and a naturally derived di-carboxylic acid (one or a combination of carboxylic acids described in conjunction with section 0). In certain embodiments, the epoxidized plant-based oil is selected from Vikoflex® 7170, Vikoflex® 7190, Vikoflex® 5075, EPOXOL® 9-5™, and/or Sefose®. In certain embodiments, the naturally derived di-carboxylic acid is selected from 13003 COOH, a novel naturally derived carboxylic acid synthesized from a polyester polyol and sebacic acid, and/or Aptalon 8520 COOH.

In further embodiments, the prepolymer blend is characterized by a mixing ratio of the combination of epoxidized plant-based oil or naturally-based glycidyl ether/ester-type epoxies (measured by epoxy amount) to the combination of di-carboxylic acids (measured by carboxylic acid amount of 1.2-1.6) in the range of 1.2-2 and more specifically 1.3-1.5.

In one embodiment, Vikoflex® 7190, Vikoflex® 5075, and 13003 COOH are combined. A mixing ratio of Vikoflex® 7190, Vikoflex® 5075, to 13003 COOH is within the range of 0.6-1:0.6-0.2:0.85 and specifically, the mixing ratio may be within the range of 0.8-0.9:0.4-0.3:0.85. An example of this embodiment is illustrated in Formulation 1.

In one embodiment, Vikoflex® 7170 and 13003 COOH are combined. A mixing ratio of Vikoflex® 7170 to 13003 COOH is within the range of 0.9-1.2:0.7 and specifically, the mixing ratio may be within the range of 1-1.1. An example of this embodiment is illustrated in Formulation 2.

In one embodiment, Vikoflex® 7190, Vikoflex® 5075, 13003 COOH, and Aptalon 8520 COOH are combined. A mixing ratio of Vikoflex® 7190, Vikoflex® 5075, 13003 COOH, to Aptalon 8520 COOH is within the range of 0.6-1:0.6-0.2:0.65:0.2 and specifically, the mixing ratio may be within the range of 0.8-0.9:0.4-0.3:0.65:0.2. An example of this embodiment is illustrated in Formulation 3.

In one embodiment, Vikoflex® 7170, 13003 COOH, and Aptalon COOH are combined. A mixing ratio of Vikoflex® 7170, 13003 COOH, to Aptalon 8520 COOH is within the range of 0.9-1.2:0.5:0.2 and specifically, the mixing ratio may be within the range of 1-1.1:0.5:0.2. An example of this embodiment is illustrated in Formulation 4.

### 6. EXAMPLES

### 6.1. Summary of the Examples

Example leather-like topcoats are formulated with as high as 96-100% plant-based carbon in the formula by using both epoxidized plant-based oils and naturally derived di-carboxylic acids in the formula.

### 6.2. General Protocol

In the following example formulations of creating a plant-based supple and durable topcoat, epoxidized plant-based oils, naturally derived polyfunctional carboxylic acids, pigments and other additives were mixed together by hand. Solvents were added to adjust the viscosity of the liquid formula, and stirred until a homogenous solution was obtained. This mixed formula was then left in a sealed container for a certain amount of time to allow air bubbles to escape. Then the mixture was cast on a release paper using a Mathis roller coating device. A 250-400 μm layer was cast and placed on a hot plate at 70° C. for a certain amount of time, typically less than one hour to allow solvent to evaporate. This layer was placed in a 160° C. oven for 20-60 minutes to cure. An additional 20-50 μm layer of the same mixed formula or different formula was then cast on top of the initial layer. Such coated bi-layer was placed in the 160° C. oven for another 3-15 minutes. A weaved or knitted fabric was then laminated on top of the adhesive layer. Following the lamination, the construction was placed in the 160° C. oven for another 20-50 minutes. After removal from the oven, all three layers were found to be well bonded together with minimal adhesive wicking through the backing fabric. The composite was separated from the release paper.

In one embodiment, the mixing ratio of the polyester polyol to the di-carboxylic acid (e.g., sebacic acid) is within the range of 1:1.9-2.1 and specifically, the mixing ratio may be within the range of 1:1.95-2.05, more specifically 1:2. In one embodiment, catalysts or solvents are not added into the mixture. Table 11 illustrates the polyester di-carboxylic acid in which the mixing ratio of Bio-Hoopol 13003 to sebacic acid is 1:2 as an example.

TABLE 11
Synthesis of 13003 COOH polyester di-carboxylic acids.

| | | Mixing ratio |
|---|---|---|
| Reactants | Equivalent weight | by amount |
| Bio-Hoopol 13003 | 1000 | 1 |
| Sebacic acid | 202 | 2 |

In one embodiment, the mixing ratio of the dimer diamine to the di-carboxylic acid (e.g., dimer acid) is within the range of 1:1.9-2.1 and specifically, the mixing ratio may be within the range of 1:1.95-2.05, more specifically 1:2. In one embodiment, catalysts or solvents are not added into the mixture. Table 12 illustrates the DDA polyamide di-carboxylic acid in which the mixing ratio of Priamine™ 1075 dimer diamine to dimer acid is 1:2 as an example.

In one instance, the dimer diamine and dimer acid have the structures illustrated below.

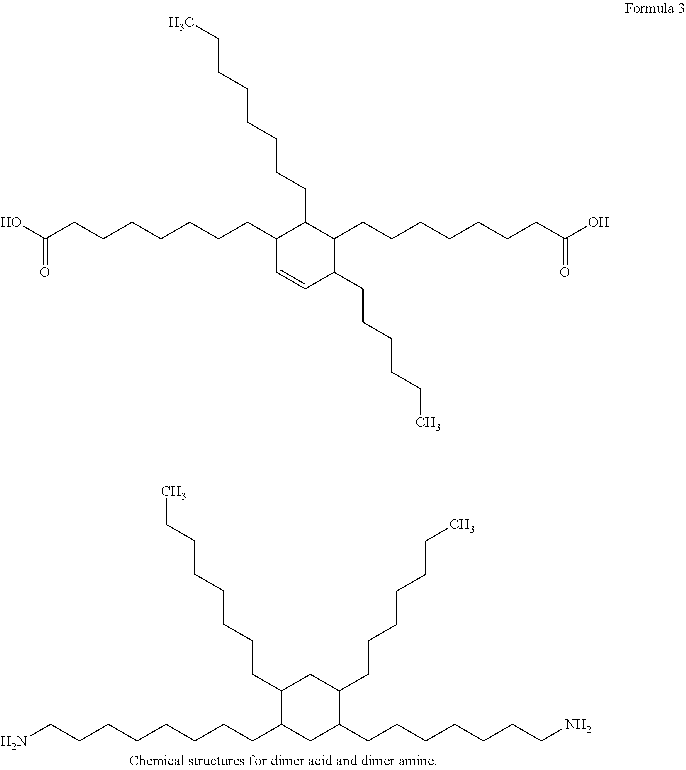 [SMILES: CCCCCCCCC1C(CCCCCCCC(=O)O)C=CC(CCCCCC)C1CCCCCCCC(=O)O ; CCCCCCCCC1CC(CCCCCCC)C(CCCCCCCN)CC1CCCCCCCCN]

TABLE 12
Synthesis of DDA polyamide di-carboxylic acids.

| | | Mixing ratio |
|---|---|---|
| Reactants | Equivalent weight | by amount |
| Priamine ™ 1075 | 275 | 1 |
| dimer diamine | | |
| Dimer acid | 282 | 2 |

### 6.3. Example Topcoat Formulations

While the topcoats include pigments, dyes, and other additives, the resin systems generally determine the mechanical and physical properties of such cured topcoats. Example topcoat resin formulas are given below.

### 6.3.1. Formulation 1

Formulation 1 illustrates a topcoat formula in which the mixing ratio of Vikoflex® 7190 to Vikoflex® 5075 to 13003 COOH are mixed with a ratio of 0.8:0.4:0.85 as an example.

| | | | Plant- | |
|---|---|---|---|---|
| | Tradename/ | Equivalent | based | Mixing ratio |
| Element | Name | weight | content | by amount |
| Epoxidized | Vikoflex ® | 174 | 100% | 0.8 |
| linseed oil | 7190 | | | |
| Epoxidized | Vikoflex ® | 319 | 92% | 0.4 |
| propylene | 5075 | | | |
| glycol dioleate | | | | |
| Polyester di- | 13003 COOH | 1200 | 100% | 0.85 |
| carboxylic acid | | | | |
| Silica rheology | CAB-O-SIL | | | 3% (by weight) |
| modifier | TS-610 | | | |
| Plant-based | XPB772 | | 100% | 2% (by weight) |
| carbon black | | | | |
| Bio-based | Acetone | | | as needed |
| solvent | | | | |

Plant-based carbon content: 99%. Tensile elongation: 460%.

### 6.3.2. Formulation 2

Formulation 2 illustrates a topcoat formula in which the mixing ratio of Vikoflex® 7170 to 13003 COOH are mixed with a ratio of 1:0.7 as an example.

| | | | Plant- | |
|---|---|---|---|---|
| | Tradename/ | Equivalent | based | Mixing ratio |
| Element | Name | weight | content | by amount |
| Epoxidized | Vikoflex ® | 174 | 100% | 1 |
| soybean oil | 7170 | | | |
| Polyester di- | 13003 COOH | 1200 | 100% | 0.70 |
| carboxylic acid | | | | |
| Silica rheology | CAB-O-SIL | | — | 3% (by weight) |
| modifier | TS-610 | | | |
| Plant-based | XPB772 | | 100% | 2% (by weight) |
| carbon black | | | | |
| Bio-based | Acetone | | | as needed |
| solvent | | | | |

Plant-based content: 100%. Tensile elongation: 360%.

### 6.3.3. Formulation 3

Formulation 3 illustrates a topcoat formula in which the mixing ratio of Vikoflex® 7190 to Vikoflex® 5075 to 13003 COOH to Aptalon 8520 COOH are mixed with a ratio of 0.8:0.4:0.65:0.2 as an example.

| | | | Plant- | |
|---|---|---|---|---|
| | Tradename/ | Equivalent | based | Mixing ratio |
| Element | Name | weight | content | by amount |
| Epoxidized | Vikoflex ® | 174 | 100% | 0.8 |
| linseed oil | 7190 | | | |
| Epoxidized | Vikoflex ® | 319 | 92% | 0.4 |
| propylene | 5075 | | | |
| glycol dioleate | | | | |
| Polyester di- | 13003 COOH | 1200 | 100% | 0.65 |
| carboxylic acid | | | | |
| Polyamide di- | Aptalon 8520 | 1000 | 82% | 0.2 |
| carboxylic acid | COOH | | | |
| Silica rheology | CAB-O-SIL | | — | 3% (by weight) |
| modifier | TS-610 | | | |
| Plant-based | XPB772 | | 100% | 2% (by weight) |
| carbon black | | | | |
| Bio-based | Acetone | | | as needed |
| solvent | | | | |

Plant-based content: 96%. Tensile elongation: 400%.

### 6.3.4. Formulation 4

Formulation 4 illustrates a topcoat formula in which the mixing ratio of Vikoflex® 7170 to 13003 COOH to Aptalon 8520 COOH are mixed with a ratio of 1:0.5:0.2 as an example.

| | | | Plant- | |
|---|---|---|---|---|
| | Tradename/ | Equivalent | based | Mixing ratio |
| Element | Name | weight | content | by amount |
| Epoxidized | Vikoflex ® | 174 | 100% | 1 |
| soybean oil | 7170 | | | |
| Polyester di- | 13003 COOH | 1200 | 100% | 0.5 |
| carboxylic | | | | |
| acid | | | | |
| Polyamide di- | Aptalon 8520 | 1000 | 82% | 0.2 |
| carboxylic | COOH | | | |
| acid | | | | |
| Silica | CAB-O-SIL | | — | 3% (by weight) |
| rheology | TS-610 | | | |
| modifier | | | | |
| Plant-based | XPB772 | | 100% | 2% (by weight) |
| carbon black | | | | |
| Bio-based | Acetone | | | as needed |
| solvent | | | | |

Plant-based content: 96%. Tensile elongation: 300%.

### Formulation 5

Formulation 5 illustrates a topcoat formula in which the mixing ratio of BRIOZEN® RD 135 G to DENACOL™ GEX-521 to 13003 COOH to Aptalon 8520 COOH are mixed with a ratio of 0.7:0.3:0.5:0.2 as an example.

| | | | Plant- | |
|---|---|---|---|---|
| | Tradename/ | Equivalent | based | Mixing ratio |
| Element | Name | weight | content | by amount |
| Diglycidyl | BRIOZEN ® | 152 | 100% | 0.7 |
| Ether of | RD 135 G | | | |
| Isosorbide | | | | |
| Polyglycerol | DENACOL ™ | 183 | 100% | 0.3 |
| Polyglycidyl | GEX-521 | | | |
| Ether | | | | |
| Polyester di- | 13003 COOH | 1200 | 100% | 0.5 |
| carboxylic acid | | | | |
| Polyamide di- | Aptalon 8520 | 1000 | 82% | 0.2 |
| carboxylic acid | COOH | | | |
| Plant-based | XPB772 | | 100% | 2% (by weight) |
| carbon black | | | | |
| Bio-based | Acetone | | | as needed |
| solvent | | | | |

Plant-based content: 96%. Tensile elongation: 320%.

### Formulation 6

Formulation 6 illustrates a topcoat formula in which the mixing ratio of BRIOZEN® RD 135 G to DENACOL™ GEX-521 to 13003 COOH to Aptalon 8520 COOH are mixed with a ratio of 0.7:0.3:0.5:0.2 as an example.

| | | | Plant- | |
|---|---|---|---|---|
| | Tradename/ | Equivalent | based | Mixing ratio |
| Element | Name | weight | content | by amount |
| Diglycidyl | BRIOZEN ® | 152 | 100% | 0.7 |
| Ether of | RD 135 G | | | |
| Isosorbide | | | | |
| Polyglycerol | DENACOL ™ | 183 | 100% | 0.3 |
| Polyglycidyl | GEX-521 | | | |
| Ether | | | | |
| Polyester di- | 13003 COOH | 1200 | 100% | 0.5 |
| carboxylic | | | | |
| acid | | | | |
| DDA | DDA COOH | 840 | 100% | 0.2 |
| polyamide di- | | | | |
| carboxylic | | | | |
| acid | | | | |
| Plant-based | XPB772 | | 100% | 2% (by weight) |
| carbon black | | | | |
| Bio-based | Acetone | | | as needed |
| solvent | | | | |

Plant-based content: 100%. Tensile elongation: 330%.

### Formulation 7

Formulation 7 illustrates a topcoat formula in which the mixing ratio of BRIOZEN® RD 135 G to PO3G 600G to DENACOL™ GEX-521 to 13003 COOH to DDA COOH are mixed with a ratio of 0.3:0.4:0.3:0.5:0.2 as an example.

| | | | Plant- | |
|---|---|---|---|---|
| | Tradename/ | Equivalent | based | Mixing ratio |
| Element | Name | weight | content | by amount |
| Diglycidyl | BRIOZEN ® | 152 | 100% | 0.3 |
| Ether of | RD 135 G | | | |
| Isosorbide | | | | |
| PO3G-based | PO3G 600G | 356 | 100% | 0.4 |
| glycidyl ether | | | | |
| Polyglycerol | DENACOL ™ | 183 | 100% | 0.3 |
| Polyglycidyl | GEX-521 | | | |
| Ether | | | | |
| Polyester di- | 13003 COOH | 1200 | 100% | 0.5 |
| carboxylic | | | | |
| acid | | | | |
| DDA | DDA COOH | 840 | 100% | 0.2 |
| polyamide di- | | | | |
| carboxylic | | | | |
| acid | | | | |
| Silica | CAB-O-SIL | | — | 3% (by weight) |
| rheology | TS-610 | | | |
| modifier | | | | |
| Plant-based | XPB772 | | 100% | 2% (by weight) |
| carbon black | | | | |
| Bio-based | Acetone | | | as needed |
| solvent | | | | |

Plant-based content: 99%.

### Formulation 8

Formulation 8 illustrates a topcoat formula in which the mixing ratio of Vikoflex® 7170 to 13003 COOH to DDA COOH are mixed with a ratio of 1:0.5:0.2 as an example.

| | | | Plant- | |
|---|---|---|---|---|
| | Tradename/ | Equivalent | based | Mixing ratio |
| Element | Name | weight | content | by amount |
| Epoxidized | Vikoflex ® | 174 | 100% | 1 |
| soybean oil | 7170 | | | |
| Polyester di- | 13003 COOH | 1200 | 100% | 0.5 |
| carboxylic | | | | |
| acid | | | | |
| DDA | DDA COOH | 840 | 100% | 0.2 |
| polyamide di- | | | | |
| carboxylic | | | | |
| acid | | | | |
| Silica | CAB-O-SIL | | — | 3% (by weight) |
| rheology | TS-610 | | | |
| modifier | | | | |
| Plant-based | XPB772 | | 100% | 2% (by weight) |
| carbon black | | | | |
| Bio-based | Acetone | | | as needed |
| solvent | | | | |

Plant-based content: 99%.

### 6.3.5. Formulation 9

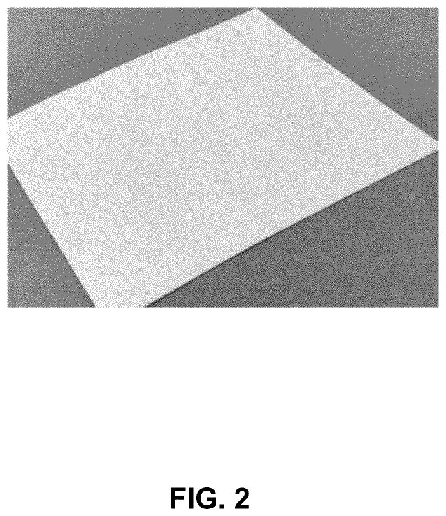

Formulation 9 illustrates a formula for plant-based foam in which the mixing ratio of Vikoflex®7190 to Vikoflex® 5075 to 13003 COOH are mixed with a ratio of 0.9:0.3:0.85 as an example. In addition to these elements, 3% by weight NACURE XC-2007 was added as a catalyst, and 9% by weight baking soda was added as a blowing agent in the example formula. A photo of such foam is presented in FIG. 2.

| | Tradename/ | Equivalent | Mixing ratio |
|---|---|---|---|
| Elements | Name | weight | by amount |
| Epoxidized linseed | Vikoflex ® | 174 | 0.9 |
| oil | 7190 | | |
| Epoxidized propylene | Vikoflex ® | 319 | 0.3 |
| glycol dioleate | 5075 | | |
| Polyester di- | 13003 COOH | 1200 | 0.85 |
| carboxylic acid | | | |
| Catalyst | NACURE XC- | | 3% (by weight) |
| | 2007 | | |
| Silica rheology | CAB-O-SIL | | 3% (by weight) |
| modifier | TS-610 | | |
| Blowing agent | Baking soda | | 9% (by weight) |

### 6.4. Results

The mechanical properties of fully cured plant-based topcoats are measured by a standard tensile elongation test. The elongation to break strain is measured by standard tensile elongation test on an Instron.

### 6.5. Example Leather Alternative Construct

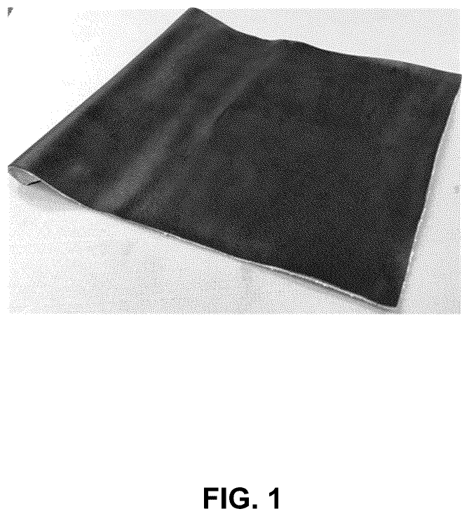

An example leather alternative construct was formed by applying the topcoat of Formulation 1 to a 100% knitted bamboo fabric as the backing textile in creating synthetic leather lab dips. A photo of such a construct is presented in FIG. 1.

### 6.6. Example Plant-Based Foam

As described with respect to section 5.3 above, the compositions for topcoat described herein is also modified to prepare plant-based foam.

Based on Formulation 5, the elements were weighed and hand-mixed in a plastic container to afford a uniform viscous liquid paste. The liquid paste was then cast to a non-sticky release substrate using a Mathis roller coating device. Such prepared sample was then placed in a 180° C. oven for 30 minutes allowing the foaming process to complete, yielding a smooth foam film with a density of circa 0.2 g/cm³.

### 7. EQUIVALENTS AND INCORPORATION BY REFERENCE

While the invention has been particularly shown and described with reference to a preferred embodiment and various alternate embodiments, it will be understood by persons skilled in the relevant art that various changes in form and details can be made therein without departing from the spirit and scope of the present disclosure.

All references, issued patents and patent applications cited within the body of the instant specification are hereby incorporated by reference in their entirety, for all purposes.

What is claimed is:

1. A coating comprising a combination of polymerized materials selected from:
(i) one or more naturally derived epoxides; and
(ii) one or more naturally derived polyfunctional carboxylic acids,
wherein a weight percent of plant derived carbon in the coating is at least 90%.

2. The coating according to claim 1, wherein the weight percent of plant-based carbon content in the coating is above 96.

3. The coating according to claim 1, wherein the one or more naturally derived epoxides are epoxidized plant-based oils selected from:
epoxidized canola oil, epoxidized corn oil, epoxidized linseed oil, epoxidized grape seed oil, epoxidized hemp seed oil, epoxidized olive oil, epoxidized peanut oil, epoxidized sesame oil, epoxidized soybean oil, epoxidized walnut oil, epoxidized sunflower oil, epoxidized high oleic canola oil, epoxidized high oleic sunflower oil, and epoxidized high oleic soybean oil.

4. The coating according to claim 1, wherein the one or more polyfunctional carboxylic acids is selected from:
monomer-type di-carboxylic acids including at least one of azelaic acid, sebacic acid, aconitic acid, a-keto glutaric acid, tartaric acid, fumaric acid, malic acid, citric acid, dodecanedioic acid, dimerized fatty acids, hydrogenated dimerized fatty acids, and Elevance Inherent® C18 diacid; and
polymer-type di-carboxylic acids including at least one of polyester di-carboxylic acids, polyamide di-carboxylic acids, polyether di-carboxylic acids, and polycarbonate di-carboxylic acids.

5. The coating according to claim 3, wherein the epoxidized plant-based oils include epoxidized soybean oil Vikoflex® 7170.

6. The coating according to claim 3, wherein the epoxidized plant-based oils include epoxidized linseed oil selected from Vikoflex® 7190 and EPOXOL® 9-5™.

7. The coating according to claim 3, wherein the plant-derived epoxides are epoxidized modified plant-based oils including epoxidized propylene glycol dioleate selected Vikoflex® 5075 and sucrose soyate Sefose®.

8. The coating according to claim 1, wherein the one or more naturally derived epoxides include epoxidized modified plant-based oils, wherein the epoxidized modified plant-based oils include a first oil with a degree of epoxy functionality below 2.5 and a second oil with a degree of epoxy functionality above 6.

9. The coating according to claim 1, wherein the first oil is epoxidized propylene glycol dioleate and the second oil is epoxidized sucrose soyate.

10. The coating according to claim 1, wherein the naturally derived epoxides include naturally-based glycidyl-ether-type epoxies, wherein the naturally-based glycidyl-ether-type epoxies is formed by reacting plant-based multiple functional alcohol with 100% bio-based epichlorohydrin, wherein the plant-based multiple functional alcohol is selected from glycerol, sorbitol, isosorbide, and propanediol.

11. The coating according to claim 1, wherein the naturally-based glycidyl-ether-type epoxies is selected from DENACOL™ GEX-313, GEX-521, GEX-622, BRIOZEN® RD 124 G, and BRIOZEN® RD 135 G.

12. The coating according to claim 1, wherein the naturally derived epoxides include naturally-based glycidyl-ester-type epoxies, wherein the naturally-based glycidyl-ester-type epoxies is formed by a process of reacting plant-based multiple functional carboxylic acid with 100% bio-based epichlorohydrin, wherein the plant-based multiple functional carboxylic acid can be selected from dimer acids and sebacic acid.

13. The coating according to claim 1, wherein the naturally-based glycidyl-ester-type epoxies include BRIOZEN® RD 133 G.

14. The coating according to claim 1, wherein the one or more polyfunctional carboxylic acids includes a polyester di-carboxylic acid formed by reacting a polyester polyol with one or more di-carboxylic acid monomers.

15. The coating according to claim 1, wherein the one or more polyfunctional carboxylic acids includes a polyamide di-carboxylic acid formed from diamines generated by a bio-fermentation process.

16. The coating according to claim 1, wherein the one or more polyfunctional carboxylic acids includes a polyamide di-carboxylic acid formed from diamines generated by a bio-industrial process.

17. The coating according to claim 1, wherein the one or more polyfunctional carboxylic acids includes branched polycarboxylic acids or hyperbranched polycarboxylic acids.

18. The coating according to claim 1, wherein the branched polycarboxylic acids or hyperbranched polycarboxylic acids are prepared by reacting multifunctional carboxylic acids monomers, or multifunctional alcohols monomers, or multifunctional amines monomers in the polymerization.

19. The coating according to claim 1, wherein the one or more polyfunctional carboxylic acids are naturally derived polyfunctional carboxylic acids and not naturally occurring polyfunctional carboxylic acids.

20. The coating according to claim 1, further comprising one or more catalyst that enables thermal curing of the coating.

21. The coating according to claim 1, wherein the one or more catalyst is an amine, phosphonium or metal type catalyst with a weight loading ratio of 0.5-3%.

22. The coating according to claim 1, wherein the one or more catalyst includes at least one of Dabco® 33-LV, NACURE XC-2007, K-PURE CXC-1765 or CYPHOS® IL 169.

23. The coating according to claim 1, further comprising one or more fillers and additives.

24. The coating according to claim 1, wherein the one or more fillers are a fume-silica type with a weight loading ratio of 0.3-3%.

25. The coating according to claim 1, wherein the coating is characterized by a tensile elongation strain of 250% or greater, 350% or greater, or 550% or greater.

26. A coated flexible substrate construct comprising:
a plant-based fabric backing; and
the coating according to claim 1.

27. The coated flexible substrate construct according to claim 26, wherein the coated flexible substrate construct further includes one or more plant-based pigments and dyes.

28. A process of making a coating, comprising:
combining one or more naturally derived epoxides and one or more naturally derived polyfunctional carboxylic acids to obtain a mixture, wherein the materials are plant-based;
combining the mixture with a solvent to create a liquid formula;
coating the liquid formula on a fabric backing; and
curing the liquid formula to form a coating on the fabric backing.

29. An article made by a process of:
combining one or more naturally derived epoxides and one or more naturally derived polyfunctional carboxylic acids to obtain a mixture, wherein the materials are plant-based;
combining the mixture with a solvent to create a liquid formula;
coating the liquid formula on a fabric backing; and
curing the liquid formula to form a coating on the fabric backing.

30. A plant-based foam comprising a combination of polymerized materials selected from:
(i) one or more naturally derived epoxides;
(ii) one or more naturally derived polyfunctional carboxylic acids; and
(iii) a blowing agent;
wherein a weight percent of plant derived carbon in the coating is at least 82%.

31. The plant-based form according to claim 30, wherein the blowing agent is selected from baking soda (sodium bicarbonate), potassium bicarbonate, azodicarbonamide, and sulfonyl hydrazide.
